(19) United States
(12) Patent Application Publication
(10) Pub. No.: US 2025/0340328 A1
(43) Pub. Date: Nov. 6, 2025

(54) FIBER-BASED CONTAINER CONTAINING A LIQUID CONDITIONING COMPOSITION

(71) Applicant: The Procter & Gamble Company, Cincinnati, OH (US)

(72) Inventors: Els Julia Kristien LESAGE, Brussels (BE); Marc Johan DECLERCQ, Strombeek-Bever (BE); Damien TERRES, Brussels (BE); Jurgen VAN POPPEL, Stekene (BE); Elena GÓMEZ PIEDRAFITA, Brussels (BE); Pierre Daniel VERSTRAETE, Woluwe Saint Lambert (BE); Lorenzo Matteo Pierre GUALCO, Brussels (BE); Laura ORLANDINI, Le Mont-sur-Lausanne (CH)

(21) Appl. No.: 19/192,555

(22) Filed: Apr. 29, 2025

Related U.S. Application Data
(60) Provisional application No. 63/641,148, filed on May 1, 2024.

(51) Int. Cl. B65D 23/02; A45D 34/00; B65D 1/02

(52) U.S. Cl. CPC B65D 23/02; A45D 34/00; B65D 1/0207

(57) ABSTRACT

A consumer product includes a liquid conditioning composition including a quaternary ammonium alkyl compound, wherein the liquid conditioning composition has a lipid bilayer phase transition temperature (Tm) of at least 25° C., wherein the liquid conditioning composition is contained in a fiber-based container including a layer of compressed pulp forming a dimensionally stable shell and enclosing an interior space, wherein the shell is at least partially coated with a layer including a polymeric material disposed on an inner surface of the shell adjacent to the interior space.

### TECHNICAL FIELD

The present invention relates to a consumer product comprising a container containing a liquid conditioning composition.

### BACKGROUND

Liquid conditioning products are contained in a wide variety of containers. Most of the containers are made of plastic material. Since plastic materials are associated with environmental concerns, some containers have been specifically designed to employ a reduced amount of plastic material for the purpose of protecting the environment.

For example, compressed pulp (or “molded pulp”, or “shaped pulp”) originating from paper, paperboard, carton, woody fibers, etc. can be used to manufacture containers. As these fiber-based containers are generally permeable to gases, liquid, grease and/or moisture, they are not adapted to be used for containing a liquid laundry composition. Attempts have been made to render fiber-based containers watertight by covering the inner surface with a barrier coating. However, it has been observed that the coating may contain defects originating either from the manufacturing process or acquired during transport or storage, leading to leakage of the contained liquid laundry composition.

Therefore, there is a continuing need to provide a consumer product with a liquid laundry composition contained in an environmentally friendly container, wherein when the barrier coating contains a defect, the liquid laundry composition is still prevented from leaking through the container.

Further, the scent of a particular liquid conditioning composition is a major driver in the consumer selection process of such consumer products. A consumer cannot clearly smell the scent of the liquid conditioning composition without first opening the cap of the consumer product. Accordingly, many consumers open such consumer products in the store before purchase. Such opening of products in stores can lead to spills and mess, and further consumer complaints when a first consumer puts a product back on shelf with a cap not fully re-tightened for a second consumer to pick up.

Therefore, there is also a continuing need to provide a consumer product with a liquid laundry composition contained in an environmentally friendly container, wherein a consumer can smell the scent of the liquid conditioning composition without first having to open the consumer product.

### SUMMARY OF THE INVENTION

A first aspect of the present invention relates to a consumer product comprising: a fiber-based container comprising: a dimensionally stable shell made of compressed pulp and having an inner surface, wherein the dimensionally stable shell has a thickness between 0.2 mm and 2.0 mm and a layer of polymeric material coating at least the inner surface of the dimensionally stable shell, the layer of polymeric material delimiting a cavity, wherein the polymeric material is selected from a polyolefin, a polyamide, a polyester, a biopolymer, a water-soluble synthetic polymer, a polysaccharide or mixtures thereof; and a liquid conditioning composition contained in the cavity, the liquid conditioning composition comprising a quaternary ammonium alkyl compound and having a lipid bilayer phase transition temperature (Tm) of at least 25° C.

A second aspect of the present invention relates to a consumer product comprising: a fiber-based container comprising: a dimensionally stable shell made of compressed pulp and having an inner surface, wherein the dimensionally stable shell has a thickness between 0.2 mm and 2.0 mm; and a layer of polymeric material coating at least the inner surface of the dimensionally stable shell, the layer of polymeric material delimiting a cavity, wherein the polymeric material is selected from a polyolefin, a polyamide, a polyester, a biopolymer, a water-soluble synthetic polymer, a polysaccharide or mixtures thereof; wherein the fiber-based container has a Perfume Diffusion Value of at least 2.0 nmol/L; and a liquid conditioning composition contained in the cavity.

### BRIEF DESCRIPTION OF THE DRAWINGS

FIG. 1 is a view of a consumer product;

FIG. 1A is a view of a container useful for the consumer products detailed herein; and

FIG. 2 shows Scanning Electron Microscope (“SEM”) images of various defects in the barrier coating.

### DETAILED DESCRIPTION OF THE INVENTION

The present disclosure relates to a consumer product having a compressed-fiber-based container containing a liquid conditioning composition having a lipid bilayer phase transition temperature (Tm) of at least 25° C. It has been surprisingly found that the lipid bilayer phase transition temperature of the liquid conditioning composition (or other liquid laundry compositions) is an important property when determining whether the liquid will leak through the pulp-based container.

The “lipid bilayer phase transition temperature” is defined as the temperature required to induce a change in the lipid physical state from the ordered gel phase, where the hydrocarbon chains are fully extended and closely packed, to the disordered liquid crystalline phase, where the hydrocarbon chains are randomly oriented and fluid.

By the terms “a” and “an” when describing a particular element, we herein mean “at least one” of that particular element. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “liquid conditioning composition” includes fabric care compositions, liquid fabric softening compositions, liquid fabric enhancing compositions, liquid fabric freshening compositions, laundry prewash, laundry pretreaters, laundry additives, spray products, dry cleaning agent or compositions, laundry rinse additives, wash additives, post-rinse fabric treatments, ironing aids, and other suitable forms that may be apparent to one skilled in the art in view of the teachings herein. Such compositions may be used as a pre-laundering treatment, a post-laundering treatment, or may be added during the rinse or wash cycle of the laundering operation.

“Compressed pulp”, “molded pulp”, “fiber-based pulp” are herein to be understood as a mixture of water, fibers (especially paper or wood fibers, potentially recycled material) and a binding agent. The pulp mixture is shaped, pressed and dried.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

According to a first aspect, the present invention relates to a consumer product comprising: a fiber-based container comprising: a dimensionally stable shell made of compressed pulp and having an inner surface, wherein the dimensionally stable shell has a thickness between 0.2 mm and 2.0 mm and a layer of polymeric material coating at least the inner surface of the dimensionally stable shell, the layer of polymeric material delimiting a cavity, wherein the polymeric material is selected from a polyolefin, a polyamide, a polyester, a biopolymer, a water-soluble synthetic polymer, a polysaccharide or mixtures thereof; and a liquid conditioning composition contained in the cavity, the liquid conditioning composition comprising a quaternary ammonium alkyl compound and having a lipid bilayer phase transition temperature (Tm) of at least 25° C.

Without wishing to be bound by theory, the dimensionally stable shell is intended to be a shell having a thickness between 0.2 mm and 2.0 mm, therefore having an intrinsic stability against internal and external pressures, including the one exerted by the a liquid conditioning composition therein.

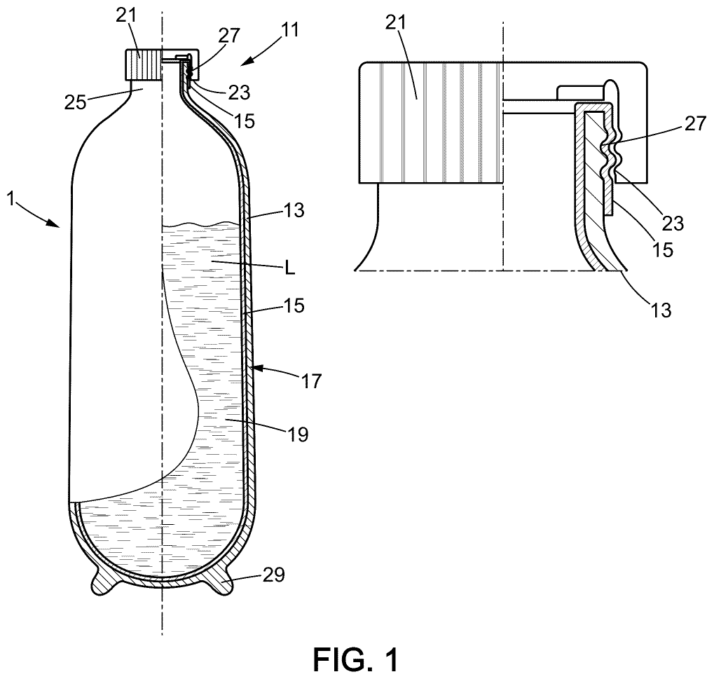

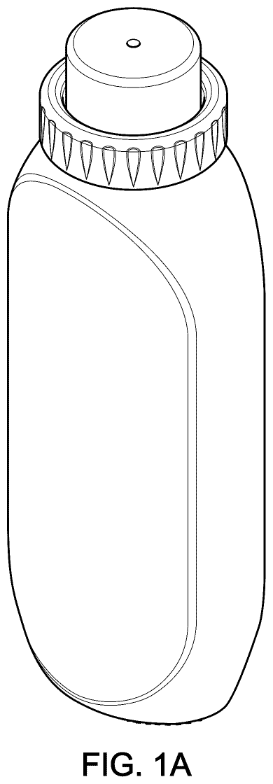

FIG. 1 is a front view of a consumer product 1. The consumer product 1 comprises a container 11. The container may be a bottle. The container 11 may have a circular, oval or polygonal cross-section (e.g. rectangle, square, octagonal, etc.), or some combination of those cross-sections (e.g., a rectangular cross-section with outwardly bowed walls). The container 11, or at least a portion thereof, may be free of sharp angles to further reduce a risk of leakage. One non-limited example of a bottle useful for the consumer products detailed herein is shown in FIG. 1A.

The container 11 comprises a dimensionally stable shell 13 constituting an external layer of the container 11. The dimensionally stable shell 13 can be formed from compressed pulp. A surrounding layer (not shown) can be attached outside of the shell 13, such as a label containing user operating instructions or legal indications pertaining to the use or content of the consumer product.

The container 11 further comprises a layer of polymeric material 15 coating an inner surface 17 of the shell 13, and in some examples (as shown), the polymeric material may also be disposed on a portion of the exterior surface of the shell. However, in other examples the polymeric material may be limited to only the inner surface of the shell (i.e., the inside of container 11). The layer of polymeric material 15 may delimit a cavity 19 which is occupied at least in part by a liquid conditioning composition L.

The cavity 19 may have a volume comprised between about 200 ml and about 3000 ml, or between about 300 ml and about 2000 ml, or between about 400 ml and about 1500 ml, or about 450 ml and 1000 ml, or between about 500 and about 750 ml.

The container may have a height comprised between 5 cm and 50 cm. The container 11 may be at least three times taller than wide.

The thickness of the layer of polymeric material may be of less than 0.3 mm and preferably less than 0.1 mm, or less than 0.05 mm, or less than 0.01 mm. The thickness of the pulp-based shell may be comprised between 0.2 mm and 2.0 mm, more preferably between 0.2 mm and 1.0 mm.

In some examples, the weight ratio of compressed pulp to polymeric material may be at least 50:50, more preferably at least 70:30, more preferably at least 80:20, more preferably at least 90:10, more preferably at least 95:5. In this context a weight ratio of “at least X:Y” should be understood as encompassing any value of ratio X1:Y1 where X1≥X and where Y1≤Y. These ratios are beneficial for the container to be processed according to various recycling streams.

The polymeric material may comprise a polyolefin or semi-crystalline polymeric material (see details below), which is applied to the inner surface 17 of the shell 13 as a fluid or powder. The polymeric material can optimally fulfil the function of the barrier between the liquid conditioning compositions detailed herein and the fiber material and the environment. The shell 13 and the layer of polymeric material 15 therefore act as a composite two-layer material in which the individual layers 13,15 fulfill different tasks in order to obtain a fluid-tight and mechanic-stable container.

The container 11 can be closed with any closure known in the art, for example, a screw cap 21 having an internal thread 23 engaging an external thread 27 of the neck 25 of the container 11. Alternative closure can be provided to the container, such as snapped-in cap, rubber lid, cork, etc.

As shown on FIG. 1, the external thread 27 of the container can be coated by the polymeric material 15 for providing additional mechanical stability and wear resistance to the screwing/unscrewing operations. Again, in other examples the polymeric material may be limited to only the inner surface of the shell (i.e., the inside of container 11).

The container may be provided with any shape and number of ribs 29 for stability purposes. The ribs 29 may be integrally formed with the fiber-based shell. The ribs shown in the illustrated example are located along the bottom of the container, but in other contemplated examples, any number of ribs may be formed along the bottom and/or sides of the container.

In some examples, the fiber-based container may have a Perfume Diffusion Value of at least 2.0 nmol/L. The Perfume Diffusion Value is measured by the test method described below.

In preferred examples, the fiber-based container may have a Perfume Diffusion Value of at least 5.0 nmol/L, preferably of at least 10.0 nmol/L, more preferably of at least 20.0 nmol/L, more preferably of at least 40.0 nmol/L.

### Polymeric Material

The polymeric material used for coating the inner surface of the shell is not limited. The polymeric material is selected from a polyolefin, a polyamide, a polyester, a biopolymer, a water-soluble synthetic polymer, a polysaccharide or mixtures thereof.

For example, the polymeric material may comprise a thermoplastic polymer selected from polyolefins, e.g. polyethylene (incl. High Density Polyethylene (“HDPE”), i.e., a polyethylene having a density ranging from 930 to 970 kg/m³) or polypropylene and copolymers thereof, polyamides and polyesters, and copolymers thereof. The polymeric material may also comprise water soluble synthetic polymers, such as polyvinyl alcohol or polysaccharides, such as cellulose.

The polymeric material may be coated from a powder, where the powder particles have an average size in the range of 1 to 200 m, preferably 5 to 100 m, more preferably 10 to 50 m. These ranges allow for an even coating, and furthermore allow for charging of the polymeric powder particles to be accomplished by the spraying device.

In some examples, the polymeric material may be constructed by a spherulitic crystallization. The crystallites are spherical, arranged radially symmetrically and firmly connected to one another via amorphous intermediate regions. The formation of spherulites at crystallization nuclei leads in particular to an excellent water vapor and oxygen barrier without the coating layer having to be stretched radially or axially.

In a further preferred embodiment, the polymeric material may have a bio-based polymer (e.g., polyolefin) content of at least 80% by weight, wherein the bio-base is defined according to the standards ASTM D 6866, CEN/TS 16137 and ISO 16620. This makes it possible to provide a fully bio-based container since the pulp-based shell is also bio-based.

In a further particularly preferred embodiment, the polymeric material may be biodegradable according to the standard DIN EN 13432. This has the advantage that biodegradable polymers can be used for the nucleation-induced crystal growth, which enables good barrier properties.

In a further preferred embodiment, the polymeric material may be applied in a powder coating process onto the pulp-based shell, with a subsequent sintering process or in a spraying process. These application methods ensure that the coating is homogeneous which is beneficial to the barrier effect of the coating. An example of a method for coating a hollow container with a powder coating is detailed in WO 2022/207507 A1, incorporated herein by reference.

In addition, it is preferred if the polymeric material is modified with a plasma coating to improve the barrier properties of the container. The additional plasma coating is preferably a glass coating based on hexamethyldisiloxane (HMDSO) or a “diamond-like carbon” coating based on acetylene.

Conveniently, the bio-based polymer can be high density polyethylene (HDPE), polyethylene terephthalate (PET), polyethylene furanoate (PEF), polyethylene isosorbide terephthalate (PEIT), polylactide (PLA), polybutylene succinate (PBS), poly-s-caprolactone (PCL) or polyhydroxyalkanoate (PHA), in particular polyhydroxybutyrate (PHB). These polymers can form spherulites under suitable processing conditions.

It is preferred if the bio-based polymer is partly produced from CO2 exhaust gases. This makes the container particularly sustainable and CO2 levels can be reduced.

It is preferred if the bio-based polymer is made from biomass. This biomass can be wood, algae, wastewater, agricultural or forestry waste, feces, household organic waste, agricultural products from overproduction or expired food.

In a further embodiment, the polymer of the coating may contain copolymers. The copolymers make it possible to lower the crystallite melting point, which means that the fiber structures of the pulp-based shell are neither affected nor destroyed by excessively high temperatures.

In a further preferred embodiment, the polymeric material has a Post-Consumer Recycled content of at least 30% by weight.

The polymer expediently may have a light barrier against UV light, visible light and infrared light, which causes a transmission reduction of at least 30% between a wavelength of 350 and 550 nm, whereby the light barrier is preferably realized by coloring the polymeric material. This avoids potential alterations to the liquid composition.

It is preferred if the polymer of the polymeric material is in linear form, branched as long chain branches and short chain branches or cross-linked.

The containers detailed herein are also preferably characterized in that they may be obtainable by applying the polymeric material as a powder to the inside of the shell by an electrostatic high-voltage process, for example an ionization process or a corona process, or a triboelectric or an electrokinetic friction process, and baking the container in a sintering furnace, wherein during the sintering process a crystalline phase grows by spherulitic crystallization and the crystallization growth occurs by adding nucleating agent and maintaining the temperature between the glass transition temperature (TG) and the crystallite melting point (Ts).

This allows particularly high crystalline proportions to form and a homogeneous layer of polymeric material to be created through sintering.

The high degree of crystallization of spherulitic (spherical) crystals and the homogeneous and defect-free layer of polymeric material lead to the excellent barrier values described above. The optimum crystallization is achieved by choosing the crystallization temperature between Ts and TG, which is determined specifically for each polymer. In a further preferred embodiment, the container is obtainable in that the partially crystalline polymer, unsaturated polymer or saturated polymer present as a liquid or gas, is applied to the inside of the shell by means of a spraying process, single- or multi-axis rotational molding, condensation process and can additionally be covered with a plasma coating. This creates a particularly homogeneous and defect-free coating, since the powdered or gaseous polymer reaches each part of the shell that is to be coated several times.

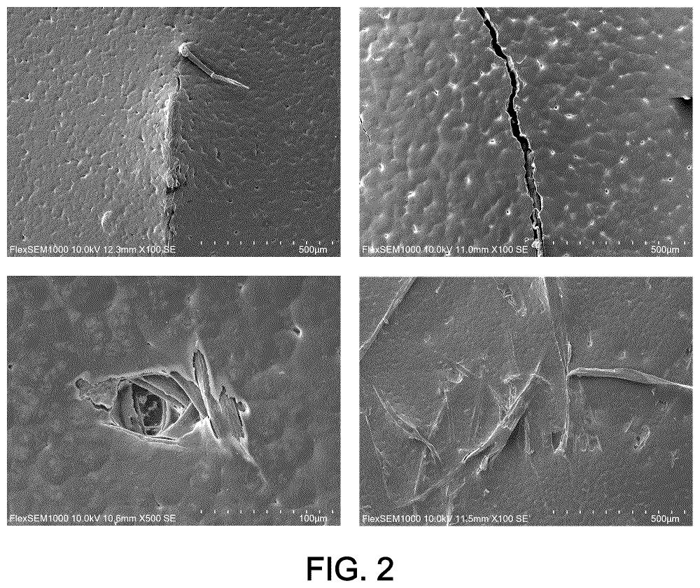

However, in mass scale production, it has been observed that the coating of a certain number of containers may still contain defects originating either from the manufacturing process or acquired during transport or storage, thus leading to leakage of the contained liquid laundry composition. FIG. 2 shows SEM images of various defects in the layer of polymeric material. The images show the coating (hence a view from the cavity noted 19 on FIG. 1). The top left image shows a fiber of the pulp-based shell extending through the coating. At this location the coating is therefore permeable to certain liquids. The top right image shows a crack which provides permeability to certain liquids. The bottom left image shows a hole, and the bottom right image shows an area with incomplete coating, both of which then make that particular location permeable to certain liquids. Such defects in the container coating will inevitably cause leaking issues with certain types of liquids stored within the container.

In some examples, the fiber-based container may have a Perfume Diffusion Value of at least 2.0 nmol/L.

In preferred examples, the fiber-based container may have a Perfume Diffusion Value of at least 5.0 nmol/L, preferably of at least 10.0 nmol/L, more preferably of at least 20.0 nmol/L, more preferably of at least 40.0 nmol/L.

### Liquid Conditioning Composition

As noted above, the liquid conditioning compositions may be fabric care compositions, preferably liquid fabric enhancers.

The liquid conditioning composition may have a viscosity from about 30 cPs to about 300 cPs (about 50 mPa-s to about 300 mPa-s), or from 80 cPs to about 300 cPs, or from 90 cPs to about 250 cPs, or preferably from 150 cPs to about 250 cPs. The viscosity is determined using a Brookfield viscometer, No. 2 spindle, at 60 RPM/s, measured at about 22° C. Compositions having viscosities lower than what is provided here may be viewed as too runny and seen as “cheap”; compositions having relatively higher viscosities may result in processing or dispensing challenges.

The liquid conditioning composition may be characterized by a dynamic yield stress. For example, the dynamic yield stress at 20° C. of the fabric softener composition may be from 0.001 Pa to 1.0 Pa, preferably from 0.005 Pa to 0.8 Pa, more preferably from 0.01 Pa to 0.5 Pa. The absence of a dynamic yield stress may lead to phase instabilities such as particle creaming or settling in case the liquid composition comprises suspended particles or encapsulated benefit agents. Very high dynamic yield stresses may lead to undesired air entrapment during filling of a bottle with the fabric softener composition. Dynamic yield stress is determined according to the method provided in the Test Methods section below.

The liquid conditioning compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that acidic pH levels facilitate stability of the ester quat.

The liquid conditioning compositions of the present disclosure may comprise water. The liquid conditioning composition may comprise from about 40% to about 98%, or from about 50% to about 96%, or from about 75% to about 95%, or from about 80% to about 94%, by weight of the composition, of water. Water levels may be selected to as to balance the amount of the softening active to a desired level. The selection of the ester quats described herein is believed to be particularly useful in compositions that comprise a relatively high amount of water, as such ingredients can provide both performance and viscosity-building benefits.

The liquid conditioning compositions of the present disclosure may further include one or more of the following ingredients set out below.

### Ester Quat

The liquid conditioning compositions of the present disclosure comprise certain alkyl quaternary ammonium ester materials, also called “ester quats” herein. Such ester quats may be useful for providing conditioning benefits such as softness, anti-wrinkle, anti-static, conditioning, anti-stretch, color, and/or appearance benefits to target fabrics. Additionally, the ester quats of the present disclosure are useful in building viscosity at relatively low active levels.

The liquid conditioning composition may comprise from about 2% to about 20%, or from about 2% to about 15%, or from about 2% to about 12%, by weight of the composition, of the ester quat softening active, described in more detail below. The composition may comprise from about 2% to about 10%, preferably from about 2% to about 8%, more preferably from about 3% to about 7%, even more preferably from about 3% to about 6% by weight of the composition, of the ester quat softening active. The composition may comprise from about 2% to about 8%, by weight of the composition, of the ester quat softening active.

Suitable quaternary ammonium ester softening actives include, but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

$$\{ R 2 ( 4 - m ) - N + - [ X - Y - R 1 ] m \} A -$$

wherein:
m is 1, 2 or 3 with proviso that the value of each m is identical;
each R1 is independently hydrocarbyl, or branched hydrocarbyl group, preferably R1 is linear, more preferably R1 is partially unsaturated linear alkyl chain;
each R2 is independently a C1-C3 alkyl or hydroxyalkyl group, preferably R2 is selected from methyl, ethyl, propyl, hydroxyethyl, 2-hydroxypropyl, 1-methyl-2 hydroxyethyl, poly(C2-3¬ alkoxy), polyethoxy, benzyl;
each X is independently —(CH2)n-, —CH2-CH(CH3)- or —CH(CH3)-CH2- and each n is independently 1, 2, 3 or 4, preferably each n is 2;
each Y is independently —O—(O)C— or —C(O)—O— or —NH—C(O)— or —C(O)—NH—;
A- is independently selected from the group consisting of chloride, methyl sulfate, and ethyl sulfate, preferably A- is selected from the group consisting of chloride and methyl sulfate;
with the proviso that when Y is —O—(O)C—, the sum of carbons in each R1 is from 13 to 21, preferably from 13 to 19. Preferably, X is —CH2-CH(CH3)- or —CH(CH3)-CH2- to further improve the hydrolytic stability of the quaternary ammonium ester softening active, and hence further improve the stability of the liquid fabric softener composition.

Because of the balance of processability and odor of the quaternary ammonium ester softening active, in preferred liquid fabric softener compositions, the iodine value of the parent fatty acid from which the quaternary ammonium fabric softening active is formed is from 0 to 100, more preferably from 10 to 60, even more preferably from 15 to 45.

The ester quat softening actives are derived from a fatty acid feedstock. The fatty acid feedstock comprises fatty acids. The fatty acid feedstock may be partially hydrogenated, as such processes can provide the desired amount of trans fatty acids. By “partially hydrogenated” as used herein, it is meant that either the fatty acids themselves undergo a partial hydrogenation process, or that the oil from which the fatty acids are derived undergoes a hydrogenation process, or both. Additionally, partial hydrogenation processes can reduce the amount of double-unsaturated fatty acids, the presence of which may lead to color and/or odor instabilities in final product. The fatty acid can be a blend of fully-hydrogenated and non-hydrogenated fatty acids.

The fatty acids may be derived from plants. Suitable sources of plant-derived fatty acids may include vegetable oils, such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, and the like. Preferably, the fatty acid feedstock comprises fatty acids that are derived from cottonseed, rapeseed, sunflower seed, or soybean, preferably from cottonseed. These materials are particularly preferred because they tend to produce fatty acids having a desirable trans-unsaturation content upon partial hydrogenation. Thus, the fatty acid feedstock may comprise partially hydrogenated fatty acids derived from plants, preferably derived from vegetable oils, more preferably derived from canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, or mixtures thereof, more preferably derived from cottonseed, rapeseed, sunflower seed, soybean, or mixtures thereof. The fatty acid may comprise, at least in part, partially hydrogenated fatty acids derived from cotton seed oil, as such materials are believed to have advantageous distributions of fatty acid types and trans-unsaturated bonds.

The fatty acid may be derived from animal fat such as tallow.

The fatty acids may include an alkyl portion containing, on average by weight, from about 13 to about 22 carbon atoms, or from about 14 to about 20 carbon atoms, preferably from about 16 to about 18 carbon atoms, where the carbon count includes the carbon of the carboxyl group. The population of fatty acids may be present in a distribution of alkyl chains sizes. A particular fatty acid may be characterized by the number of carbons in its alkyl portion. For example, a fatty acid having sixteen carbons in the alkyl portion may be called a “C16 fatty acid.” Likewise, a fatty acid having eighteen carbons in the alkyl portion may be called a “C18 fatty acid.”

The fatty acid feedstock may comprise less than 25%, by weight of the fatty acid feedstock, of C16 fatty acids. The fatty acid feedstock may comprise from about 5% to about 25%, preferably from about 10% to about 25%, more preferably from about 15% to about 25%, even more preferably from about 20% to about 25%, by weight of the fatty acid feedstock, of C16 fatty acids. It may be desirable to limit the relative amount of C16 fatty acids in the fatty acid feedstock. Without wishing to be bound by theory, it is believed that a relatively high proportion of C16 fatty acids (especially relative to C18 fatty acids) may lead to relatively lower viscosities in the final product.

Additionally, or alternatively, it may be desirable to have at least a certain minimum of C16 fatty acids in the fatty acid feedstock (e.g., at least 10%, preferably at least 15%, even more preferably at least 20%, by weight of the fatty acid feedstock). Such materials can help to improve processability, as esterquats based on materials that include C16 fatty acids tend to have lower melting points and may be relatively easier to disperse compared to esterquats produced primarily from the more crystalline C18 (and/or C18-trans) fatty acids with low/nil levels of C16s.

The alkyl quaternary ammonium ester softening actives may comprise compounds formed from fatty acids that are unsaturated, meaning that the fatty acids comprise at least one double bond in the alkyl portion. The fatty acids may be monounsaturated (one double bond), or they may be di-unsaturated (or double-unsaturated; two double bonds). Preferably, most of the unsaturated fatty acids in the fatty acid feedstock are monounsaturated.

The fatty acids may comprise unsaturated C18 chains, which may include a single double bond (“C18:1”) or may be double unsaturated (“C18:2”). (For reference, a fatty acid with a saturated C18 chain may be referred to as “C18:0”.) The fatty acid feedstock may comprise from about 50% to about 85%, preferably from about 60% to about 80%, more preferably from about 70% to about 80%, by weight of the fatty acid feedstock, of C18 fatty acids, regardless of saturated or unsaturated status. The fatty acid feedstock may comprise from about 20% to about 60%, preferably from about 40% to about 60%, more preferably from about 45% to about 55%, by weight of the fatty acid feedstock, of C18:0 fatty acids. The fatty acid feedstock may comprise from about 15% to about 50%, preferably from about 15% to about 30%, preferably from about 18% to about 25%, by weight of the fatty acid feedstock, of C18:1 fatty acids. The fatty acid feedstock may comprise from 0% (e.g., none) to about 20%, or from about 0% to about 15%, or from about 0% to about 10%, or from about 0% to about 5%, by weight of the fatty acid feedstock, of C18:2 fatty acids. The fatty acid feedstock may comprise from about 1% to about 15%, preferably from about 5% to about 10%, by weight of the fatty acid feedstock, of C18:2 fatty acids.

The ester quat material may be produced in a two-step synthesis process. First, an esteramine may be produced by running an esterification reaction using fatty acids and an alkanolamine. In a second step, the product may be quaternized using an alkylating agent.

The liquid conditioning compositions of the present disclosure may comprise other conditioning agents in addition to the ester quats described above. The other conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

Examples of suitable quaternary ammonium ester softening actives are commercially available from KAO Chemicals under the trade name Tetranyl® AT-1 and Tetranyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, and Stepantex® VL90A.

These types of agents and general methods of making them are disclosed in U.S. Pat. No. 4,137,180.

### Perfume and Perfume Delivery Systems

The liquid conditioning compositions may comprise perfume, a perfume delivery system, or a combination thereof. Such systems may improve the freshness performance of the compositions described herein. In particular, perfume delivery systems may facilitate improved freshness performance by increasing deposition efficiency, facilitating perfume release at different touchpoints, and/or increasing longevity of perfume performance.

### Neat Perfume

Perfume may be present as neat oil, sometimes referred to as, for example, “free” perfume, unencapsulated perfume, or free perfume oil. The liquid conditioning compositions may comprise from about 0.01% to about 5%, or from about 0.05% to about 4%, or from about 0.1% to about 3%, or from about 0.5% to about 2%, by weight of the composition, or free perfume oil.

Neat oil can comprise perfume raw materials such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, New Jersey, USA, International Flavors & Fragrances Corp. of South Brunswick, New Jersey, USA, or Firmenich Company of Geneva, Switzerland or Encapsys Company of Appleton, Wisconsin (USA). As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

### Perfume Delivery Systems

The perfume delivery system may comprise encapsulates, for example, where a core is surrounded by wall material (“core-shell encapsulates”); the core may comprise perfume and optionally a partitioning modifier (e.g., isopropyl myristate). The wall material may include melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

The polyurea based wall material may comprise a polyisocyanate. The shell of the delivery particles may comprise a polymeric material that may be the reaction product of a polyisocyanate and a chitosan. The shell may comprise a polyurea resin, where the polyurea resin comprises the reaction product of a polyisocyanate and chitosan. The delivery particles of the present disclosure may be considered polyurea delivery particles and include a polyurea-chitosan shell. (As used herein, “shell” and “wall” are used interchangeably with regard to the delivery particles, unless indicated otherwise.) The shell may be derived from isocyanates and chitosan.

The delivery particles may be made according to a process that comprises the following steps: forming a water phase comprising chitosan in an aqueous acidic medium; forming an oil phase comprising dissolving together at least one benefit agent and at least one polyisocyanate; forming an emulsion by mixing under high shear agitation the water phase and the oil phase into an excess of the water phase, thereby forming droplets of the oil phase and benefit agent dispersed in the water phase; curing the emulsion by heating, for a time sufficient to form a shell at an interface of the droplets with the water phase, the shell comprising the reaction product of the polyisocyanate and chitosan, and the shell surrounding the core comprising the droplets of the oil phase and benefit agent. Diluents, for example isopropyl myristate, may be used to adjust the hydrophilicity of the oil phase. The oil phase is then added into the water phase and milled at high speed to obtain a targeted size. The emulsion is then cured in one or more heating steps.

The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the particles. The slurry is then cooled to room temperature.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in wall formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl)methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the invention comprise isocyanate monomers, oligomers or prepolymers, or dimers or trimers thereof, having at least two isocyanate groups. Optimal crosslinking can be achieved with polyisocyanates having at least three functional groups.

Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene 5 diisocyanate.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100).

The shell may degrade at least 50% after 20 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The delivery particles may be characterized by a ratio of core to shell up to 99:1, or even 99.5:1, on the basis of weight.

The encapsulates may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

The perfume delivery system may comprise particles that comprise a graft copolymer and a fragrance material, where the graft copolymer comprises a polyalkylene glycol (e.g., polyethylene glycol) as a graft base and one or more side chains that comprise vinyl acetate moieties.

The perfume delivery system may comprise a pro-perfume, for example a siloxane-based pro-perfume, where a perfume raw material is associated with (for example, via covalent bonding) a polymer (e.g., a siloxane polymer) upon delivery to a surface and is released upon or after treatment of a surface with the composition.

When the perfume delivery system includes formaldehyde derivatives, such as perfume encapsulates with melamine-formaldehyde shells, the composition may further comprise a formaldehyde scavenger, which may comprise a sulfur-based formaldehyde scavenger, a non-sulfur-based formaldehyde scavenger, or mixtures thereof. Suitable non-sulfur-based formaldehyde scavengers may include urea, ethylene urea, acetoacetamide, or mixtures thereof. Suitable sulfur-based formaldehyde scavengers may include alkali and/or alkali earth metal dithionites, pyrosulfites, sulfites, bisulfites, metasulfites, monoalkyl sulphites, dialkyl sulphites, dialkylene sulphites, sulfides, thiosulfates, thiocyanates, mercaptans, thiourea, and mixtures thereof.

### Treatment Adjuncts

The liquid conditioning compositions of the present disclosure may include other treatment adjunct ingredients. The adjunct ingredients may be selected to provide, for example, processing, stability, and/or performance benefits.

Suitable treatment adjuncts may include surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, structurants, anti-agglomeration agents, coatings, formaldehyde scavengers, and/or pigments.

In particular, the liquid conditioning composition may further comprise a treatment adjunct selected from the group consisting of: additional conditioning agents, dyes, pH control agents, solvents, rheology modifiers, structurants, cationic polymers, surfactants, perfume, perfume delivery systems, chelants, antioxidants, preservatives, or mixtures thereof.

The precise nature of these additional components, and levels of incorporation thereof, will depend on the physical form of the composition and the nature of the operation for which the resulting composition is to be used. However, when one or more adjuncts are present, such one or more adjuncts may be present as detailed below. The following is a non-limiting list of adjunct ingredients that may be useful.

### 1. Rheology Modifier/Structurant

The liquid conditioning compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as perfume encapsulates as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon Inc. under the tradename Carbopol Aqua 30. Another suitable structurant is sold under the tradename Flosoft FS 222 available from SNF Floerger.

### 2. Cationic Polymer

The liquid conditioning compositions of the present disclosure may comprise a cationic polymer. Cationic polymers may serve as deposition aids, e.g., facilitating improved deposition efficiency of softening and/or freshness actives onto a target surface. Additionally or alternatively, cationic polymers may provide stability, structuring, and/or rheology benefits to the composition.

The liquid conditioning compositions may comprise, by weight of the composition, from 0.0001% to 3%, preferably from 0.0005% to 2%, more preferably from 0.001% to 1%, or from about 0.01% to about 0.5%, or from about 0.05% to about 0.3%, of a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The cationic polymer may comprise a cationic polysaccharide, such as cationic starch, cationic cellulose, cationic guar, or mixtures thereof. The cationic cellulose may comprise a quaternized hydroxyethyl cellulose. Polymers derived from polysaccharides may be preferred, being naturally derived and/or sustainable materials.

The cationic polymer may comprise a cationic acrylate. The cationic polymer may comprise cationic monomers, nonionic monomers, and optionally anionic monomers (so long as the overall charge of the polymer is still cationic. The cationic polymer may comprise cationic monomers selected from the group consisting of methyl chloride quaternized dimethyl aminoethylammonium acrylate, methyl chloride quaternized dimethyl aminoethylammonium methacrylate and mixtures thereof. The cationic polymer may comprise nonionic monomers selected from the group consisting of acrylamide, dimethyl acrylamide and mixtures thereof. The cationic polymer may optionally comprise anionic monomers selected from acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS), and their salts.

The cationic polymer may substantially linear or may be cross-linked. The composition may comprise both a substantially linear cationic polymer (e.g., formed with less than 50 ppm cross-linking agent) and a cross-linked cationic polymer (e.g., formed with greater than 50 ppm cross-linking agent). Such combinations may provide both deposition and structuring benefits.

### 3. Surfactant

The liquid conditioning compositions may include less than 5%, or less than 2%, or less than 1%, or less than about 0.1%, by weight of the composition, of anionic surfactant, or even be substantially free of anionic surfactant. Anionic surfactants can negatively impact the stability and/or performance of the present compositions, as they may undesirably interact with cationic components such as the conditioning compounds. Product compositions intended to be added during the rinse cycle of an automatic washing machine, such as a liquid fabric enhancer, may include relatively low levels of anionic surfactant. Additionally or alternatively, compositions intended to be used in combination with a detergent composition during the wash cycle of an automatic washing machine may include relatively low levels of anionic surfactant.

The liquid conditioning compositions may comprise nonionic surfactant. Such surfactants may provide, for example, stability and/or processing benefits. The nonionic surfactants may be emulsifiers, for example, of perfume. The nonionic surfactants may be alkoxylated fatty alcohols, such as ethoxylated C10-C18 fatty alcohols.

### 4. Chelant

The liquid conditioning compositions may comprise a chelant (aka, chelating agent). Such agents may be iron and/or manganese and/or other metal ion chelating agents. Such chelating agents can be selected from the group consisting of amino carboxylates, amino phosphonates, polyfunctionally-substituted aromatic chelating agents, and mixtures therein. If utilized, these chelating agents will generally comprise from about 0.1% to about 15%, preferably from about 0.1% to about 3.0%, by weight of the compositions described herein. More preferably, if utilized, the chelating agents will comprise from about 0.1% to about 3.0% by weight of such compositions.

Suitable chelants may include: diethylenetriaminepentaacetic acid (DTPA); hydroxyethanedimethylenephosphonic acid (HEDP); MGDA (methylglycinediacetic acid); glutamic acid, N,N-diacetic acid (GLDA); 1,2-diydroxybenzene-3,5-disulfonic acid (Tiron™); ethylenediamine disuccinate (EDDS); diethylenetriamine penta(methylene phosphonic acid) (DTPMP); ethylenediaminetetrakis (methylenephosphonates); ethylenediaminetetracetates; N-(hydroxyethyl) ethylenediaminetriacetates; nitrilotriacetates; ethylenediamine tetraproprionates; triethylenetetraaminehexacetates; diethylenetriamine-pentaacetates; ethanoldiglycines; alkali metal, ammonium, or substituted ammonium salts thereof; dihydroxydisulfobenzenes such as 1,2-dihydroxy-3,5-disulfobenzene; and mixtures thereof.

### 5. Antioxidants

The liquid conditioning compositions may comprise an antioxidant, preferably a phenolic antioxidant, more preferably a tocopherol antioxidant or a derivative thereof. Antioxidants in the presently disclosed composition may be useful for malodor control, cleaning performance, and/or color stability, as they may help to reduce yellowing that may be associated with amines. Furthermore, and without wishing to be bound by theory, it is believed that the presence of an antioxidant will reduce the rate of auto-oxidation of the trans-unsaturated bonds of the ester quat fatty acid chains and may therefore contribute to viscosity stability of the compositions. Antioxidants are substances as described in Kirk-Othmer (Vol. 3, page 424) and in Ullmann's Encyclopedia (Vol. 3, page 91).

The compositions of the present disclosure may include an antioxidant, preferably a phenolic antioxidant, even more preferably a tocopherol or a derivative thereof, in an amount of from about 0.001% to about 2%, preferably from about 0.01% to about 0.5%, by weight of the composition.

A specifically preferred class of antioxidants for use in the compositions of the present disclosure are tocopherols and derivatives thereof, such as tocotrienols. Such antioxidants are typically naturally derived and therefore may be of particular interest to be coupled with an ester quat material for sustainability/environmental reasons. Furthermore, such compounds may be viewed by the consumer as familiar, beneficial, and safe due to the vitamin E activity of the compounds. Tocopherols useful in the present compositions may include alpha-tocopherol, beta-tocopherol, gamma-tocopherol, delta-tocopherol, or combinations thereof.

Other suitable antioxidants may include other phenolic antioxidants, such as butylated hydroxytoluene (“BHT”; specifically, 3,5-di-tert-butyl-4-hydroxytoluene) and butylated hdroxyanisol (“BHA”). Still other suitable antioxidants may include Proxel GXL™, Trolox™ Raluquin™, and/or those sold under the TINOGARD® tradename.

### 6. Preservative

The liquid conditioning composition may comprise a preservative, which can help with product stability upon storage. The preservative may comprise a diphenyl ether antimicrobial agent, preferably 4-4′-dichloro-2-hydroxydiphenyl ether, 2,4,4′-trichloro-2′-hydroxydiphenyl ether, or combinations thereof. The preservative may comprise a quaternary ammonium antimicrobial agent, preferably dialkyl quaternary ammonium antimicrobial agents. Suitable preservative may include those sold under the TINOSAN and/or BARQUAT tradenames.

### 7. Additional Conditioning Agents

The liquid conditioning compositions of the present disclosure may comprise other conditioning agents in addition to the ester quats described above. The additional conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

The composition may include a combination of a quaternary ammonium ester compound and a silicone. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1. When determining amounts of quaternary ammonium ester compounds as described in this paragraph, the amount may refer to ester quats as described in the previous section, or the total amount of ester quats as described above, plus any additional quaternary ammonium ester compounds that may be present.

As noted above, in some examples, the quaternary ammonium alkyl compound is a quaternary ammonium alkyl ester compound derived from fatty acids having C16-C18 alkyl chains, wherein the quaternary ammonium alkyl ester compound and/or the fatty acids from which it is derived is characterized by an Iodine Value of from 0 to 90.

### Properties of the Liquid Conditioning Compositions

The liquid conditioning composition has a lipid bilayer phase transition temperature (Tm) of at least 25° C. The lipid bilayer phase transition temperature is defined as the temperature required to induce a change in the lipid physical state from the ordered gel phase, where the hydrocarbon chains are fully extended and closely packed, to the disordered liquid crystalline phase, where the hydrocarbon chains are randomly oriented and fluid. This property has been determined to be decisive for avoiding leakage in the event of a defect in the container coating (see experiments below).

In some examples, the lipid bilayer phase transition temperature of the liquid conditioning composition is of at least 25° C., 33° C., at least 35° C. or at least 37° C.

In some examples, the enthalpy (per unit weight of ester quat) in the liquid conditioning composition (specific latent heat per unit weight of ester quat) is at least 0.02 J/g/g.

FIG. 2 shows SEM images of various defects in the layer of polymeric material. The images show the coating (hence a view from the cavity noted 19 on FIG. 1). The top left image shows a fiber of the pulp-based shell extending through the coating. At this location the coating is therefore permeable. The top right image shows a crack. The bottom left image shows a hole, and the bottom right image shows an area with incomplete coating. These examples show various kinds of defects of the coating. These defects may result from an imperfect coating operation or from an event during storage or transport.

In each case, the defect in the coating leads the liquid to enter in direct contact with one or more fibers of the fiber-based shell. This would normally result in leakages. However, as shown below, when specifically choosing liquid conditioning compositions to pair with the containers detailed herein, it is possible to avoid leakages.

A second aspect of the present invention relates to a consumer product comprising: a fiber-based container comprising: a dimensionally stable shell made of compressed pulp and having an inner surface, wherein the dimensionally stable shell has a thickness between 0.2 mm and 2.0 mm; and a layer of polymeric material coating at least the inner surface of the dimensionally stable shell, the layer of polymeric material delimiting a cavity, wherein the polymeric material is selected from a polyolefin, a polyamide, a polyester, a biopolymer, a water-soluble synthetic polymer, a polysaccharide or mixtures thereof; wherein the fiber-based container has a Perfume Diffusion Value of at least 2.0 nmol/L; and a liquid conditioning composition contained in the cavity, wherein the Perfume Diffusion Value is measured by placing the liquid conditioning composition in a 10-liter Tedlar bag, wherein said bag is sealed, and purged with nitrogen (N₂) for 2.5 hours, wherein air samples are collected using an SKC AirChek 3000 pump with Tenax TA traps and analyzed by GC-MS to identify target compounds.

In a preferred aspect, the fiber-based container may have a Perfume Diffusion Value of at least 5.0 nmol/L, preferably of at least 10.0 nmol/L, more preferably of at least 20.0 nmol/L, more preferably of at least 40.0 nmol/L.

In another preferred aspect, the liquid conditioning composition may comprise a quaternary ammonium alkyl compound and having a lipid bilayer phase transition temperature (Tm) of at least 25° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

### Test Methods

### DSC Method for Measuring Tm:

A method for determining the transition temperature (Tm) of the lipid bilayer of fabric enhancer solutions using a Differential Scanning Calorimeter (DSC) is explained hereinafter. The method employs a TA Instruments Q2000 DSC instrument equipped with a refrigerated cooling accessory (RCS90). 10 mg of the sample is accurately pipetted into Tzero hermetic aluminum pans provided by TA instruments. The DSC instrument is purged with nitrogen (N₂) at a flow rate of 50 mL/min. To measure Tm, the DSC pan containing the sample is carefully placed in the instrument. A temperature program is then initiated, which involves heating the sample from 0° C. to 90° C. at a controlled rate of 5° C./min, followed by cooling to −5° C. at the same rate of 5° C./min. During this process, distinct endothermic and exothermic peaks are observed in the respective heating and cooling DSC curves, indicating the transition of the lipid bilayer.

To analyze the DSC curves, the following steps are performed. First, the peaks are identified visually in the DSC curves, usually there is a pre-transition (small change in enthalpy) temperature followed by the main transition (large change of enthalpy) temperature, with the endothermic peak representing the heating process and the exothermic peak representing the cooling process. Next, a baseline is defined, which is the area before and beyond the endothermic/exothermic peaks where there aren't any thermal events. In DSC context a flat baseline refers to a stable and consistent baseline observed in absence of any thermal events or transition during a DSC measurement. However, certain factors, such as instrument noise, baseline drift can cause slight deviations from a perfectly flat baseline. One should carefully assess the baseline stability as area with absence of any thermal events. The integration limits are then selected to encompass the peak, capturing the entire thermal transition. The integration limits are defined by the curve intersections with the baseline. Baseline-to-Baseline Integration is applied, this involves integrating the area between two baseline points on either side of the peak. The baseline points are selected to represent the flat regions of the curve before and after the peak.

The temperature corresponding to the peak maximum is denoted as Tm, representing the transition temperature of the lipid bilayer. Additionally, the integrated peak area is reported in units of J/g (Joules per gram), providing a measure of the energy absorbed or released during the phase transition. This energy, or enthalpy, or specific latent heat, can be divided by the amount of ester quat with the purpose of comparing the energy required per unit weight of ester quat to transition a gram of liquid composition.

### Analytical Method for Perfume Diffusion Measurements Across LFE Bottles

### Samples Description

Three different types of bottles were filled with commercial Lenor liquid softener “fresh air” variants and stored one week at room temperature before the assessment for perfume diffusion. The bottles assessed were:
1 commercial PET Lenor Fresh Air bottle 770 mL
1 commercial HDPE bottle used for Ariel liquid detergent 1250 mL
4 identical fiber-based containers according to the invention

### Method Description

The samples were introduced in 10 L tedlar bags. The bags were sealed and filled with N2 gas. After 2.5 h of equilibration time at room temperature, 2 L of air were sampled 2 times per bag (within 5 min), using the SKC AirChek 3000 pump at 1 L/min, and the Tenax TA traps (Gerstel tubes 013742-505-00 filled with Tenax TA 35/60). The samples were analyzed via Gas Chromatography (GC)-Mass Spectrometry (MS) with the parameters indicated in the next section.

### GC-MS Parameters

All analyses were performed on a system comprising a GC (Agilent 7890A) equipped with a Thermal Desorption Unit (TDU) and a MS (Agilent 5975C inert MSD) as a detector. The TDU was operated in splitless mode, and the following parameters were used: 40° C., held for 1 minute; ramped to 220° C. (60° C./min), held for 10 minutes. The Cooled Injection System (CIS) was programed as follows: cooled to −100° C. with liquid nitrogen, held for 0.05 minutes, heated to 300° C. at 12° C./min, held for 5 minutes. The liner used was a CIS glass liner packed with Tenax TA. Separation was performed on an Agilent J&W DB-5 GC column (60 m×0.32 mm×0.25 in) with helium as a carrier gas at a constant pressure of 100.4 kPa and a flowrate of 2.3 mL/min. The oven was programmed as follows: 50° C., held for 2 minutes, then heated to 285° C. at 10° C./min. A full scan mode (m/z 35-300) was applied for the identification of the target compounds. Via an automated external calibration set-up, the GC-MS area response data are calculated to nmol/L. The compounds which signal showed saturation have been excluded.

### EXAMPLES

### Results

The Table 1 below shows the Total perfume concentration measured in the bags. The total perfume concentration that diffused from the fiber-based container in the bag is about 170 times higher compared to the commercial PET bottle and 24 times higher compared to a commercial HDPE bottle. The perfume raw materials (PRMs) diffuse more through the fiber-based bottle.

TABLE 1

| | PET | HDPE | Fiber-based container |
|---|---|---|---|
| Mean total PRM | 0.2 | 1.7 | 40.6 |
| concentration (nmol/L) | | | |

The PRM headspace concentrations in the tedlar bags are expressed as concentration ratios for fiber-based container vs. PET and HDPE vs. PET as showed in Table 2. We observed the same effect on diffusion for the individual PRMs.

TABLE 2
Individual PRM Headspace concentration in Tedlar bag expressed
as ratio for fiber-based vs. PET and HDPE vs. PET.

| | | | | Vapor | | | |
|---|---|---|---|---|---|---|---|
| | | Paboco/PET | HDPE/PET | Pressure | | | Boiling |
| | | Conc. | Conc. | at 25 C., | | MW, | Point, |
| PRM Name | CAS | Ratio | Ratio | torr | cLogP | g/mol | C. |
| AMYL | 2050-08-0 | 64 | 7 | 0.00144 | 4.21 | 208.3 | 303.4 |
| SALICYLATE | | | | | | | |
| BENZYL | 140-11-4 | 92 | 8 | 0.164 | 1.94 | 150.2 | 213.9 |
| ACETATE | | | | | | | |
| DIMETHYL | 151-05-3 | 100 | 7 | 0.0139 | 3.32 | 192.3 | 235.1 |
| BENZYL | | | | | | | |
| CARBINYL | | | | | | | |
| ACETATE | | | | | | | |
| FLOR | 5413-60-5 | 48 | 3 | 0.0137 | 2.79 | 192.3 | 273.8 |
| ACETATE | | | | | | | |
| FRUTENE | 68912-13-0 | 46 | 3 | 0.00488 | 3.32 | 206.3 | 294 |
| IONONE | 127-51-5 | 58 | 2 | 0.00282 | 4.22 | 206.3 | 281.5 |
| GAMMA | | | | | | | |
| METHYL | | | | | | | |
| VERDOX | 88-41-5 | 85 | 7 | 0.103 | 4.46 | 198.3 | 222.7 |

### Perfume Character Assessment

A panel of 3 expert perfumers smelled the coded and sealed fiber-based containers filled with market samples of Lenor Fresh Air Blue and Pink and compared with the neat samples in an open PET container.

Based on olfactive characteristics, the three expert perfumers could recognize the variants without opening the fiber-based containers.

There is an absolute consensus as the key olfactive notes of both perfumes are clearly recognizable through the fiber-based containers. Comparative tests

The following compositions have been tested to establish the specific properties leading to an absence of leakage.

TABLE 3
compositions A to G

| Liquid | | | | | | | | | | | |
|---|---|---|---|---|---|---|---|---|---|---|---|
| composition | A | | B | | C | | D | | E | F | G |
| Lipid Bilayer | 52 | | 48 | | 38 | | 24 | | 0 | 45 | 0 |
| Transition | | | | | | | | | | | |
| temperature | | | | | | | | | | | |
| (Tm) | | | | | | | | | | | |
| Iodine Value | 0.4 | | 22 | | 44 | | 66 | | 88 | 21 | >100 |
| fatty acid | | | | | | | | | | | |
| feedstock | | | | | | | | | | | |
| Viscosity Final | 7 | cps | 10 | cps | 13 | cps | 25 | cps | 27 cps | 5 cps | 11 cps |
| product | | | | | | | | | | | |
| Enthalpy | 3.36 | J/g | 2.39 | J/g | 1.47 | J/g | 0.35 | J/g | — | >2 | — |

| | | | | | | | |
|---|---|---|---|---|---|---|---|
| (dispersion) | | | | | | | |
| Enthalpy in | 0.134 | 0.096 | 0.059 | 0.014 | | | |
| J/g/g active | | | | | | | |
| Esterquat (1) | 4% | 4% | 4% | 4% | 4% | | |
| Esterquat (2) | | | | | | | 4% |
| Esterquat (3) | | | | | | | |
| Esterquat (4) | | | | | | 2.9% | |
| Coconut oil | | | | | | 0.1% | |
| Isopropanol | 0.4% | 0.4% | 0.4% | 0.4% | 0.4% | 0.2% | 0.4% |
| Ethanol | | | | | | | |
| HCl | 0.01% | 0.01% | 0.01% | 0.01% | 0.01% | 0.01% | — |
| Formic acid | 0.05% | 0.05% | 0.05% | 0.05% | 0.05% | 0.05% | — |
| NaHEDP | 0.01% | 0.01% | 0.01% | 0.01% | 0.01% | 0.01% | — |
| Perfume | | | | | | | |
| Flosft FS222 | | | | | | | |
| from SNF | | | | | | | |
| Perfume | | | | | | | |
| Microcapsules | | | | | | | |
| Antifoam | | | | | | 0.02% | |
| emulsion (20% | | | | | | | |
| Active) | | | | | | | |
| Demineralized | balance | balance | balance | balance | balance | balance | balance |
| water | | | | | | | |

TABLE 4
compositions I to L and P

| Liquid | | | | | | | |
|---|---|---|---|---|---|---|---|
| composition | I | | J | K | L | P | |
| Lipid Bilayer | 34 | | | | | 33 | |
| Transition | | | | | | | |
| temperature | | | | | | | |
| (Tm) | | | | | | | |
| Iodine Value | 22 | | | | | | |
| fatty acid | | | | | | | |
| feedstock | | | | | | | |
| viscosity Final | 170 | cps | 1 cps | 83 cps | 614 cps | 7 | cps |
| product | | | | | | | |
| Enthalpy | 0.8 | J/g | | | | 0.4 | J/g |

| | | | | | |
|---|---|---|---|---|---|
| (dispersion) | | | | | |
| Enthalpy in | 0.022 | | | | 0.016 |
| J/g/g active | | | | | |
| Esterquat (1) | 2.8% | | | | 4% |
| Esterquat (2) | | | | | |
| Esterquat (3) | | | | | |
| Esterquat (4) | | | | | |
| Coconut oil | 0.1% | | | | |
| Isopropanol | 0.2% | | | | 0.4% |
| Ethanol | | | | | |
| HCl | 0.01% | | | | 0.01% |
| Formic acid | 0.05% | | | | 0.05% |
| NaHEDP | 0.01% | | | | 0.01% |
| Perfume | 1.0% | | | | |
| Flosft FS222 | 0.5% | | 0.4% | 0.7% | |
| from SNF | | | | | |
| Perfume | 0.2% | | | | |
| Microcapsules | | | | | |
| Antifoam | 0.02% | | | | |
| emulsion (20% | | | | | |
| Active) | | | | | |
| Demineralized | balance | 100% | balance | balance | balance |
| water | | | | | |

TABLE 5
compositions M to O

| | M | | | O |
|---|---|---|---|---|
| | (Lenor Fresh Air | | N | (Comfort Ultimate |
| | Concentrated ® | | (Comfort Blue Skies ® | Care ® |
| Liquid | Product Code | | Product Code 3237 7P4 | Product Code 3033 |
| composition | 3018030371) | | 1459) | 6P4 1 050) |
| Lipid Bilayer | 34 | | 27 | 31 |
| Transition | | | | |
| temperature | | | | |
| (Tm) | | | | |
| viscosity Final | 180 | cps | | |
| product | | | | |
| Enthalpy | 2.8 | J/g | 0.8 J/g | 3.4 J/g |

| (dispersion) | | | |
|---|---|---|---|
| Enthalpy in | 0.168 | | |
| J/g/g active | | | |
| Demineralized | balance | balance | balance |
| water | | | |

Where:
esterquat (1) is Methyl Diethanolamine, esterified with C16, C18 and c18 unsaturated fatty acids, quaternized with methyl Chloride.
esterquat (2) Triethanol amine, esterified with C16, C18 and c18 unsaturated fatty acids derived from Canola oil, quaternized with Di Methyl Sulphate.
esterquat (3) Triethanol amine, esterified with C16, C18 and c18 unsaturated fatty acids, quaternized with Di Methyl Sulphate.
esterquat (4) Ethanaminium, 2-hydroxy-N-(2-hydroxyethyl)-N,N-dimethyl-, esters with C16-18 and C18-unsatd. fatty acids, chlorides.

### Testing Protocol

The amount of liquid passing through the pulp-based layer has been measured qualitatively and quantitatively.

The qualitative approach consists of a set of 2D samples made according to the above description is prepared (i.e. comprising a layer of compressed pulp coated with a polymeric material). Cuts are made in the coating thereby exposing the fibers directly to the liquid. A same amount of liquid of each composition A to P has been placed on respective samples (two samples per composition).

The samples are left for 1 hour in a chamber under controlled temperature and hygrometry. A first set of experiments has been performed at 23° C. and 50% RH. Liquid penetration is observed (wetting of the fibers).

The quantitative approach consists of the preparation of a set of fiber 2D samples (i.e. compressed pulp coated), without any polymeric material to focus on fiber surface-liquid interactions. A same amount of liquid of each composition A to P has been placed on respective samples (two samples per composition).

The samples are left for 5 minutes in a chamber under controlled temperature and hygrometry. A first set of experiments has been performed at 23° C. and 50% RH. Liquid penetration is measured via gravimetry.

The comparative results are presented in the following table:

TABLE 6
results

| Liquid | Liquid |
|---|---|
| composition | penetration |
| A | No |
| B | No |
| C | No |
| D | Yes |
| E | Yes |
| F | No |
| G | Yes |
| I | No |
| J | Yes |
| K | Yes |
| L | Yes |
| M | No |
| N | No |
| O | No |
| P | Yes |

These results show that:
water (composition J) penetrates through the pulp where the coating is damaged;
viscosity is not a decisive property: e.g. compositions K and L of a very different viscosity, yet both penetrate through the pulp;
the nature of esterquat is not the driver to leakage or no leakage (see for instance the comparison between compositions D, G, I and P);
the decisive property appears to be the lipid bilayer transition temperature (Tm): compositions having a Tm value above 25° C. do not leak through the pulp-based container (see the whole range of compositions and in particular compositions D and N). Not to be bound by theory, a high enthalpy of the phase transition may hinder molecular re-arrangement and therefore also be beneficial in protecting against leakage. Hence a secondary key property seems to be an enthalpy greater than 0.02 J/g/g (see compositions D, I and P).

Without wishing to be bound by theory, the mechanism that prevents leakage may be related to the fact that some of the compositions are not prone to absorption via capillarity. This is due to a contact angle between the liquid composition and the pulp-based layer that is above 90°. Hence, irrespective of the viscosity or surface tension, a high enough lipid bilayer transition temperature seems to provide a contact angle greater than 90° at room temperature.

Other experiments, carried out at 50° C. confirm the relationship between the transition temperature and the ability to prevent leakage. Hence, only the compositions with a transition temperature of at least 25° C., at least 33° C., at least 35° C., or at least 37° C. would prevent leakage at temperatures up to these values.

The results are independent from the nature of the coating. The results are also valid for various kinds of compressed pulps (e.g. liquid carton board).

### Analytical Method for Perfume Diffusion Value (PDV) Measurements Across Liquid Conditioning Composition Bottles

To improve the user experience and/or to assist the selection of a given consumer product in a retail shop, it may be convenient to provide a container which enables a user to smell the liquid composition through the container. Further, it is desired to provide a container which enables a user to smell the liquid composition through the container without impacting the freshness experience at other touchpoints (e.g., opening the bottle, pouring the liquid fabric conditioner into the machine, etc.) The following describes a method for objectively measuring the smell permeability of a consumer product.

### Method Description

Samples (consumer products with liquid composition) were introduced in respective 10-liter tedlar bags (VWR #24634). The bags were sealed and filled with N2 gas. After 2.5 hours of equilibration time at room temperature, 2 liters of air were sampled 2 times per bag (within 5 minutes), using a SKC AirChek 3000 pump at 1 L/min, and the Tenax TA traps (Gerstel tubes 013742-505-00 filled with Tenax TA 35/60). The samples were analyzed via GC-MS with following parameters:

All analyses were performed on a system comprising a GC (Agilent 7890A) equipped with a TDU2 and a MS (Agilent 5975C inert MSD) as a detector. The TDU was operated in splitless mode, and the following parameters were used: 40° C., held for 1 min; ramped to 220° C. (60° C./min), held for 10 min. The CIS was programed as follows: cooled to −100° C. with liquid nitrogen, held for 0.05 min, heated to 300° C. at 12° C./min, held for 5 min. The liner used was a CIS glass liner packed with Tenax TA. Separation was performed on an Agilent J&W DB-5 GC column (60 m×0.32 mm×0.25 μm) with helium as a carrier gas at a constant pressure of 100.4 kPa and a flow rate of 2.3 mL/min. The oven was programmed as follows: 50° C., held for 2 min, then heated to 285° C. at 10° C./min. A full scan mode (m/z 35-300) was applied for the identification of the target compounds. Via an automated external calibration set-up, the GC-MS area response data are calculated to nmol/L. The compounds which signal showed saturation have been excluded.

The following samples were tested:
S1: 1 PET container filled with 770 mL of Lenor Fresh Air®;
S2: 1 HDPE container filled with 1250 mL of Lenor Fresh Air® (normally used for Ariel®); and
S3: A container as described in the present disclosure (i.e. fiber-based dimensionally stable shell and inner polymer coating that the contained liquid conditioner composition did not leak through) filled with Lenor Fresh Air®. Four tests were run using identical S3 containers and the results were averaged (standard deviation included in the results below).

### Results

The total perfume concentration (nmol/L), i.e., Perfume Diffusion Value (PDV) that diffused from the S3 sample in the bag (40.6 nmol/L+/−10 nmol/L; taken as an average of 4 samples tested) is about 170 times higher compared to sample S1 (0.244 nmol/L) and 24 times higher compared to sample S2 (1.73 nmol/L). The perfume raw materials (PRMs) diffuse more through the S3 sample bottle. The PRM headspace concentrations in the tedlar bags are expressed as concentration ratios for S3 vs. S1 and S2 vs. S1 as shown in Table 6. We observed the same effect on diffusion for the individual PRM.

TABLE 6
results

| | | | | Vapor | | | |
|---|---|---|---|---|---|---|---|
| | | S3/S1 | | Pressure | | | Boiling |
| | CAS | PDV | S2/S1 | at 25 C., | | MW, | Point, |
| PRM Name | Number | Ratio | PDV Ratio | torr | cLogP | g/mol | C. |
| AMYL | 2050-08-0 | 64 | 7 | 0.00144 | 4.21 | 208.3 | 303.4 |
| SALICYLATE | | | | | | | |
| BENZYL | 140-11-4 | 92 | 8 | 0.164 | 1.94 | 150.2 | 213.9 |
| ACETATE | | | | | | | |
| DIMETHYL | 151-05-3 | 100 | 7 | 0.0139 | 3.32 | 192.3 | 235.1 |
| BENZYL | | | | | | | |
| CARBINYL | | | | | | | |
| ACETATE | | | | | | | |
| FLOR | 5413-60-5 | 48 | 3 | 0.0137 | 2.79 | 192.3 | 273.8 |
| ACETATE | | | | | | | |
| FRUTENE | 68912-13-0 | 46 | 3 | 0.00488 | 3.32 | 206.3 | 294 |
| IONONE | 127-51-5 | 58 | 2 | 0.00282 | 4.22 | 206.3 | 281.5 |
| GAMMA | | | | | | | |
| METHYL | | | | | | | |
| VERDOX | 88-41-5 | 85 | 7 | 0.103 | 4.46 | 198.3 | 222.7 |

This data shows that the consumer product of the present disclosure has a substantial benefit regarding the diffusion of the smell of the liquid fabric enhancer through the container. Accordingly, a consumer can pick up the consumer product on shelf and smell the liquid conditioning composition contained therein without opening the bottle. Further, a consumer can readily smell the liquid conditioning composition contained within the consumer products as the consumer approaches the point-of-sale display.

What is claimed is:

1. A consumer product comprising:
a fiber-based container comprising: a dimensionally stable shell made of compressed pulp and having an inner surface, wherein:
the dimensionally stable shell has a thickness between 0.2 mm and 2.0 mm and a layer of polymeric material coating at least the inner surface of the dimensionally stable shell, the layer of polymeric material delimiting a cavity, and
the polymeric material is selected from a polyolefin, a polyamide, a polyester, a biopolymer, a water-soluble synthetic polymer, a polysaccharide or mixtures thereof; and
a liquid conditioning composition contained in the cavity, the liquid conditioning composition comprising a quaternary ammonium alkyl compound and having a lipid bilayer phase transition temperature (Tm) of at least 25° C.

2. The consumer product of claim 1, wherein the enthalpy in the liquid conditioning composition is at least 0.02 J/g/g.

3. The consumer product of claim 1, wherein the liquid conditioning composition has a lipid bilayer phase transition temperature of at least 33° C., or at least 35° C. or at least 37° C.

4. The consumer product of claim 1, wherein the quaternary ammonium alkyl compound is a quaternary ammonium alkyl ester compound derived from fatty acids having C16-C18 alkyl chains, wherein the quaternary ammonium alkyl ester compound and/or the fatty acids from which it is derived is characterized by an Iodine Value of from 0 to 90.

5. The consumer product of claim 1, wherein the polymeric material comprises a polyolefin, a polyester, a biopolymer, or a mixture thereof, preferably the polymeric material comprises High Density Polyethylene (HDPE).

6. The consumer product of claim 1, wherein the layer of polymeric material has a thickness of less than 0.3 mm, or less than 0.1 mm, or less than 0.05 mm.

7. The consumer product of claim 1, wherein the polymeric material is biobased.

8. The consumer product of claim 1, wherein the polymeric material is biodegradable according to the standard DIN EN 13432.

9. The consumer product of claim 1, wherein the weight ratio of compressed pulp to polymeric material is at least 50:50, more preferably at least 70:30, more preferably at least 80:20, more preferably at least 90:10, more preferably at least 95:5.

10. The consumer product of claim 1, wherein the cavity has a volume comprised between 200 ml and 3000 ml, preferably between 500 ml and 750 ml.

11. A consumer product comprising a liquid conditioning composition comprising a quaternary ammonium alkyl compound, wherein the liquid conditioning composition has a lipid bilayer phase transition temperature (Tm) of at least 25° C. and an enthalpy of at least 0.02 J/g/g, wherein the liquid conditioning composition is contained in a fiber-based container comprising a layer of compressed pulp forming a dimensionally stable shell and enclosing an interior space, wherein the shell is at least partially coated with a layer comprising a polymeric material disposed on an inner surface of the shell adjacent to the interior space.

12. A consumer product comprising:
a fiber-based container comprising: a dimensionally stable shell made of compressed pulp and having an inner surface, wherein the dimensionally stable shell has a thickness between 0.2 mm and 2.0 mm; and
a layer of polymeric material coating at least the inner surface of the dimensionally stable shell, the layer of polymeric material delimiting a cavity, wherein the polymeric material is selected from a polyolefin, a polyamide, a polyester, a biopolymer, a water-soluble synthetic polymer, a polysaccharide or mixtures thereof;
wherein the fiber-based container has a Perfume Diffusion Value of at least 2.0 nmol/L; and
a liquid conditioning composition contained in the cavity,
wherein the Perfume Diffusion Value is measured by placing the liquid conditioning composition in a 10-liter Tedlar bag, wherein said bag is sealed, and purged with nitrogen (N₂) for 2.5 hours, wherein air samples are collected using an SKC AirChek 3000 pump with Tenax TA traps and analyzed by GC-MS to identify target compounds.

13. The consumer product of claim 12, wherein the fiber-based container has a Perfume Diffusion Value of at least about 5.0 nmol/L.

14. The consumer product of claim 12, wherein the fiber-based container has a Perfume Diffusion Value of at least about 10.0 nmol/L, more preferably at least about 20.0 nmol/L, more preferably at least about 40.0 nmol/L.

15. The consumer product of claim 12, wherein the liquid conditioning composition comprises a quaternary ammonium alkyl compound and having a lipid bilayer phase transition temperature (Tm) of at least 25° C.
